(19) United States
(12) Patent Application Publication
(10) Pub. No.: US 2015/0319224 A1
(43) Pub. Date: Nov. 5, 2015

(54) Method and System for Presenting Personalized Content

(71) Applicant: Yahoo Inc., Sunnyvale, CA (US)

(72) Inventor: Li Rong, Beijing (CN)

(21) Appl. No.: 14/344,185

(22) PCT Filed: Mar. 15, 2013
(86) PCT No.: PCT/CN2013/000303

§ 371 Date: Mar. 11, 2014

(51) Int. Cl. H04L 29/08; G06F 17/30

(52) U.S. Cl. CPC H04L 67/10; G06F 17/30876

(57) ABSTRACT

Method and system for presenting content, is provided. A range with respect to a presenting device is determined. A device identification (ID) of the presenting device is transmitted, via the communication platform, to a first user located within the range. First content is obtained, wherein the first content is generated based on a first request from the first user. The first request is sent in association with at least the device ID and a first user ID of the first user. The first content is presented, at the presenting device, wherein the first content is personalized with respect to the first user.

### BACKGROUND

1. Technical Field

The present teaching relates generally to content presentation.

2. Discussion of Technical Background

There are more and more public advertisements in an outdoor environment, e.g., at an airport, at a public square, in a taxi, etc. The public advertisements are usually shown on a board provided for displaying content. Some conventional public board is scheduled for displaying predetermined content without any regard as to who will be viewing the content.

Effort has been made to enable an ads board to change content to be displayed according to some recognition as to what is near the ads board. For example, by taking pictures of people in front of a ads board, it can be recognized whether there are women or men in front of an ads board. Then content can be selected suitable for, detected women in front of the ads board, so that the content to be displayed has some relevance to the audience watching the ads board. However, such conventional approaches cannot selectively display content that is personalized with respect to specific users who are in front of the ads board at that moment. Therefore, there is a need to develop a solution for presenting personalized content to a user nearby based on individual users.

### SUMMARY

The present teaching describes methods, systems, and programming for presenting personalized content.

In one exemplary embodiment, a method, implemented on at least one machine having at least one processor, storage, and a communication platform connected to a network for presenting content, is provided. A range with respect to a presenting device is determined. A device identification (ID) of the presenting device is transmitted, via the communication platform, to a first user located within the range. First content is obtained, wherein the first content is generated based on a first request from the first user. The first request is sent in association with at least the device ID and a first user ID of the first user. The first content is presented, at the presenting device, wherein the first content is personalized with respect to the first user.

In another exemplary embodiment, a method, implemented on at least one machine having at least one processor, storage, and a communication platform connected to a network for presenting content, is provided. A range with respect to a presenting device is determined. The presenting device has a device ID. A first user ID is detected. The first user ID is associated with a first user located within the range. A first request is generated in association with at least the device ID and the first user ID. First content is obtained, wherein the first content is personalized based on the first request. The first content is presented at the presenting device.

In still another exemplary embodiment, a method, implemented on at least one machine having at least one processor, storage, and a communication platform connected to a network for presenting content, is provided. A first request is received, wherein the first request is sent in association with at least a device ID of a presenting device and a first user ID of a first user. The first user is located within a predetermined range with respect to the presenting device. First content is generated, wherein the first content is personalized based on the first request. The first content is transmitted to the presenting device, wherein the presenting device presents the first content.

In yet another exemplary embodiment, an apparatus including at least one processor, storage, and a communication platform connected to a network for presenting content, is provided. The apparatus comprises a transmission controlling unit, a transmitting unit, a content obtaining unit, and a presenting unit. The transmission controlling unit is configured for determining a range with respect to the apparatus. The transmitting unit is configured for transmitting, via the communication platform, a device ID of the apparatus to a user located within the range. The content obtaining unit is configured for obtaining content generated based on a request from the user, wherein the request is sent in association with at least the device ID and a user ID of the user. The presenting unit is configured for presenting the content, wherein the content is personalized with respect to the user.

In a different exemplary embodiment, an apparatus including at least one processor, storage, and a communication platform connected to a network for presenting content, is provided. The apparatus comprises a detection controlling unit, a detecting unit, a requesting unit, a content obtaining unit, and a presenting unit. The detection controlling unit is configured for determining a range with respect to the apparatus, wherein the apparatus has a device ID. The detecting unit is configured for detecting a user ID associated with a user located within the range. The requesting unit is configured for generating a request in association with at least the device ID and the user ID. The content obtaining unit is configured for obtaining content personalized based on the request. The presenting unit is configured for presenting the content.

In another exemplary embodiment, an apparatus including at least one processor, storage, and a communication platform connected to a network for presenting content, is provided. The apparatus comprises a request processing unit and a content generating unit. The request processing unit is configured for receiving a request for content, wherein the request is sent in association with at least a device ID of a presenting device and a user ID of a user. The user is located within a predetermined range with respect to the presenting device. The content generating unit is configured for generating content personalized based on the request and transmitting the content to the presenting device, wherein the presenting device presents the content.

In still another exemplary embodiment, a system including at least one machine having at least one processor, storage, and a communication platform connected to a network for presenting content, is provided. The system comprises a presenting device, a serving device, and a content presentation mechanism residing in both the presenting device and the serving device. The mechanism enables the presenting device to determine a range with respect to the presenting device and transmit a device ID of the presenting device to a user located within the range. The mechanism enables the serving device to receive a request from the user, wherein the request is sent in association with at least the device ID and a user ID of the user ID, generate content personalized with respect to the user based on the request, and transmit the content to the presenting device. The mechanism enables the presenting device to receive the content from the serving device and present the content.

In yet another exemplary embodiment, a system including at least one machine having at least one processor, storage, and a communication platform connected to a network for presenting content, is provided. The system comprises a presenting device having a device ID, a serving device, and a content presentation mechanism residing in both the presenting device and the serving device. The mechanism enables the presenting device to determine a range with respect to the presenting device, detect a user ID associated with a user located within the range, generate a request in association with at least the device ID and the user ID, and transmit the request to the serving device. The mechanism enables the serving device to receive the request, generate content personalized with respect to the user based on the request, and transmit the content to the presenting device. The mechanism enables the presenting device to receive the content from the serving device, and present the content.

Other concepts relate to software for presenting content. A software product, in accord with this concept, includes at least one machine-readable non-transitory medium and information carried by the medium.

In one exemplary embodiment, a machine-readable tangible and non-transitory medium having information for presenting content, wherein the information, when read by the machine, causes the machine to determine a range with respect to a presenting device, transmit, via the communication platform, a device identification (ID) of the presenting device to a first user located within the range, obtain first content generated based on a first request from the first user, wherein the first request is sent in association with at least the device ID and a first user ID of the first user; and present, at the presenting device, the first content, wherein the first content is personalized with respect to the first user.

In a different exemplary embodiment, a machine-readable tangible and non-transitory medium having information for presenting content, wherein the information, when read by the machine, causes the machine to determine a range with respect to a presenting device having a device ID, detect a first user ID associated with a first user located within the range, generate a first request in association with at least the device ID and the first user ID, obtain first content personalized based on the first request, and present, at the presenting device, the first content.

In yet another exemplary embodiment, a machine-readable tangible and non-transitory medium having information for presenting content, wherein the information, when read by the machine, causes the machine to receive a first request, wherein the first request is sent in association with at least a device ID of a presenting device and a first user ID of a first user, and the first user is located within a predetermined range with respect to the presenting device, generate first content personalized based on the first request, and transmit the first content to the presenting device, wherein the presenting device presents the first content.

### BRIEF DESCRIPTION OF THE DRAWINGS

The embodiments will be more readily understood in view of the following description when accompanied by the below figures and wherein like reference numerals represent like elements, wherein:

FIG. 1 (PRIOR ART) illustrates an exemplary system for presenting content based on appearances of users;

FIG. 2 illustrates an exemplary system for presenting personalized content based on user identifications (IDs) of users, in accordance with one embodiment of the present teaching;

FIG. 3 illustrates another exemplary system for presenting personalized content based on user IDs of users, in accordance with one embodiment of the present teaching;

FIG. 4 is a block diagram of an exemplary embodiment of a content display device, in accordance with one embodiment of the present teaching;

FIG. 5 is a flow chart of an exemplary process performed by a content display device, in accordance with one embodiment of the present teaching;

FIG. 6 is a block diagram of an exemplary embodiment of a user device, in accordance with one embodiment of the present teaching;

FIG. 7 is a flow chart of an exemplary process performed by a user device, in accordance with one embodiment of the present teaching;

FIG. 8 is a block diagram of an exemplary embodiment of a content server, in accordance with one embodiment of the present teaching;

FIG. 9 is a flow chart of an exemplary process performed by a content server, in accordance with one embodiment of the present teaching;

FIG. 10 is a block diagram of another exemplary embodiment of a content display device, in accordance with one embodiment of the present teaching;

FIG. 11 is a flow chart of another exemplary process performed by a content display device, in accordance with one embodiment of the present teaching;

FIG. 12 is a block diagram of another exemplary embodiment of a user device, in accordance with one embodiment of the present teaching;

FIG. 13 is a flow chart of another exemplary process performed by a user device, in accordance with one embodiment of the present teaching;

FIG. 14 depicts a general mobile device architecture on which the present teaching can be implemented; and

FIG. 15 depicts a general computer architecture on which the present teaching can be implemented.

### DETAILED DESCRIPTION

Reference will now be made in detail to the embodiments of the present teaching, examples of which are illustrated in the accompanying drawings. While the present teaching will be described in conjunction with the embodiments, it will be understood that they are not intended to limit the present teaching to these embodiments. On the contrary, the present teaching is intended to cover alternatives, modifications, and equivalents, which may be included within the spirit and scope of the present teaching as defined by the appended claims.

In addition, in the following detailed description of embodiments of the present teaching, numerous specific details are set forth in order to provide a thorough understanding of the present teaching. However, it will be recognized by one of ordinary skill in the art that the present teaching may be practiced without these specific details. In other instances, well-known methods, procedures, components, and circuits have not been described in detail as not to unnecessarily obscure aspects of the embodiments of the present teaching.

Various embodiments in accordance with the present teaching provide method and system related to content presentation. More specifically, the method and system in various embodiments of the present teaching relate to presenting, at a present device, personalized content to a user based on a user identification (ID) of the user.

There may be a plurality of users passing by a presenting device. Each user may carry a user device that can communicate with the presenting device within a predetermined range with respect to the presenting device. When a user carrying a user device is located in the predetermined range, the user device may send a user ID to the presenting device; or the presenting device may send a device ID to the user device. Then a request for content may be sent to a content server, either by the user device or by the presenting device. The request can be in association with both the user ID and the device ID. Based on the user ID, a user profile may be retrieved at the content server to obtain personalized information associated with the user. Personalized content may be generated based on the personalized information reflecting some specific interests of the individual user. The personalized content can be sent to and presented at the presenting device to the user. Since the user is located within the predetermined range, the user can view, at the present device, some content personalized specifically for the user.

Additional novel features will be set forth in part in the description which follows, and in part will become apparent to those skilled in the art upon examination of the following and the accompanying drawings or may be learned by production or operation of the examples.

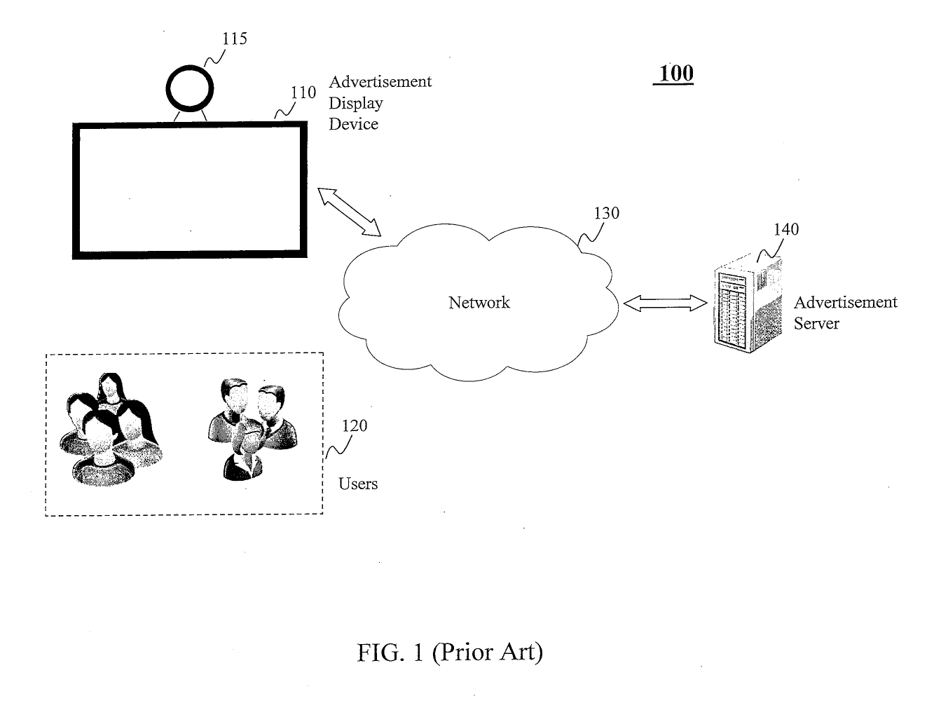

FIG. 1 (PRIOR ART) illustrates an exemplary system 100 for presenting content based on appearances of users. The system 100 may include an advertisement display device 110, a network 130, an advertisement server 140, and a plurality of users 120. The advertisement display device 110 can show advertisements obtained from the advertisement server 140, via the network 130.

The advertisements can be generated and shown based on appearances of the users 120 captured by a camera 115 connected to the advertisement display device 110. For example, if most of the users 120 look like young people, some advertisements related to sports or popular songs may be shown. If most of the users 120 look like male, some advertisements about beer may be shown.

However, this strategy cannot address an identified personal interest for each of the users 120. For example, there may be some young people who dislike popular songs. There may be some males who dislike beer. Further, there may be some males who can appear like a female. Thus, the estimated interest based on an appearance might not be very reliable.

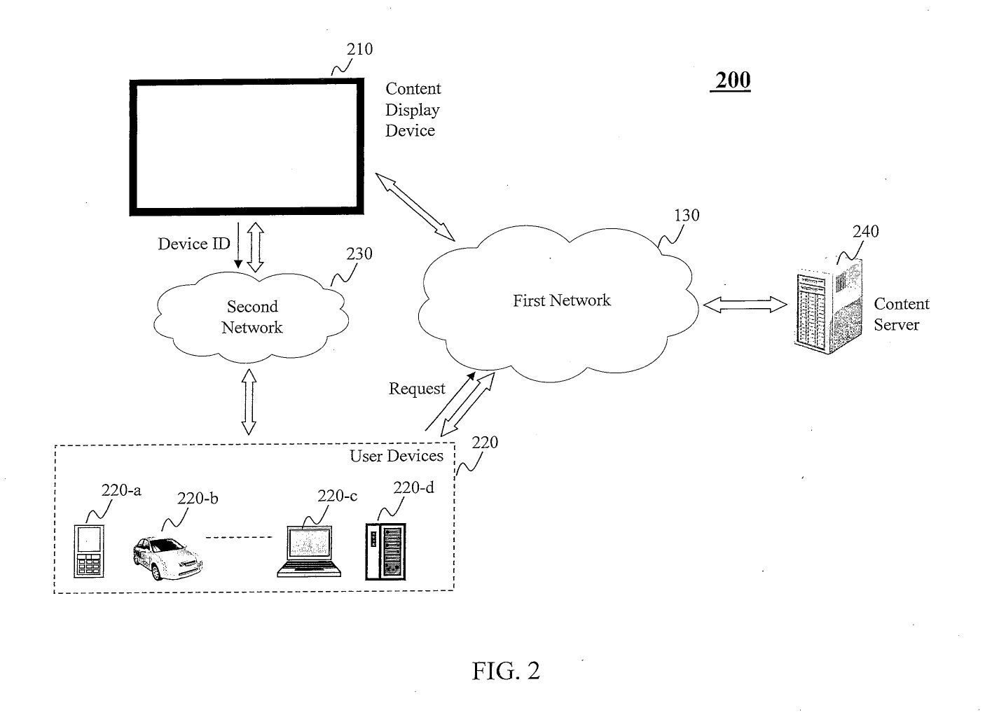

FIG. 2 illustrates an exemplary system 200 for presenting personalized content based on user IDs of users, in accordance with one embodiment of the present teaching. The system 200 may include a content display device 210, a first network 130, a second network 230, a content server 240, and a plurality of user devices 220 carried by some users. The content display device 210 can present content obtained from the content server 240, via the first network 130.

The first network 130 and the second network 230 in the system 200 can be a single network or a combination of different networks. For example, the first network 130 can be a local area network (LAN), a wide area network (WAN), a public network, a private network, a proprietary network, a Public Telephone Switched Network (PSTN), the Internet, a wireless network, a virtual network, or any combination thereof. The second network 230 can be a wireless network like Wi-Fi, Bluetooth, a wireless network wherein Radio-Frequency Identification (RFID) can be used, or any combination thereof. The first network 130 and the second network 230 may be connected in accordance with some embodiments.

Different from the system 100, the content presented on the content display device 210 in the system 200 may be generated based on an identified personal interest associated with a user. The identified personal interest may be determined based on a user ID of the user. For example, each of the user devices 220 carried by a user may have a user ID stored for the user. If a user carrying a user device, device 220-a for example, is located within a predetermined range with respect to the content display device 210, the device 220-a may communicate with the content display device 210, via the second network 230.

A user ID of a user may represent a user account associated with one of the user's online activities or real life activities. The online activities may include internet browsing, online shopping, online chatting, email exchanging, online social networking, online searching, etc. The real life activities may include shopping at a supermarket, visiting a zoo, going to hospital, etc. All of those online activities and real life activities may have records indicating some personal interests related to the user. The records may be stored at or retrieved by the content server 240, upon a request with the corresponding user ID.

As shown in FIG. 2, when a user carrying a user device is close to the content display device 210, a device sent out by the content display device 210 may be detected by a user device, via the second network 230. For example, suppose the second network 230 is a Bluetooth network around the content display device 210 and a user carrying a user device approaches the content display device 210. Then if a device ID is sent out by the content display device 210, the device ID can be detected by the user device, via the Bluetooth network. Otherwise, if the user is far from the content display device 210, the device ID sent by the content display device 310 cannot be detected at the user device, since Bluetooth has a relatively short propagation range in wireless networks. It can be understood that in some embodiments, when a user is close to the content display device 210 such that a user ID can be sent from the user device to the content display device 210, the user can see and view the content presented at the content display device 210. Therefore, when the presented content is personalized based on the user's identified interest, there is high probability that the user can be attracted by the presented content.

Upon receiving the device ID, the user device may send a request to the content server 240. The request may include both the device ID and the user ID. The content server 240 can retrieve records associated with the user ID to determine some identified personal interests for the user, and generate personalized content based on the identified personal interests. The personalized content can be sent to and presented at a content display device 210 associated with the device ID.

When there are multiple requests sent from a group of users, the content server 240 may generate some integrated content to reflect interests of the group of users. The generated content for different users in the group in this case, may be presented at the content display device 210, at different portions of a screen at the same time, or at the whole screen but at different time.

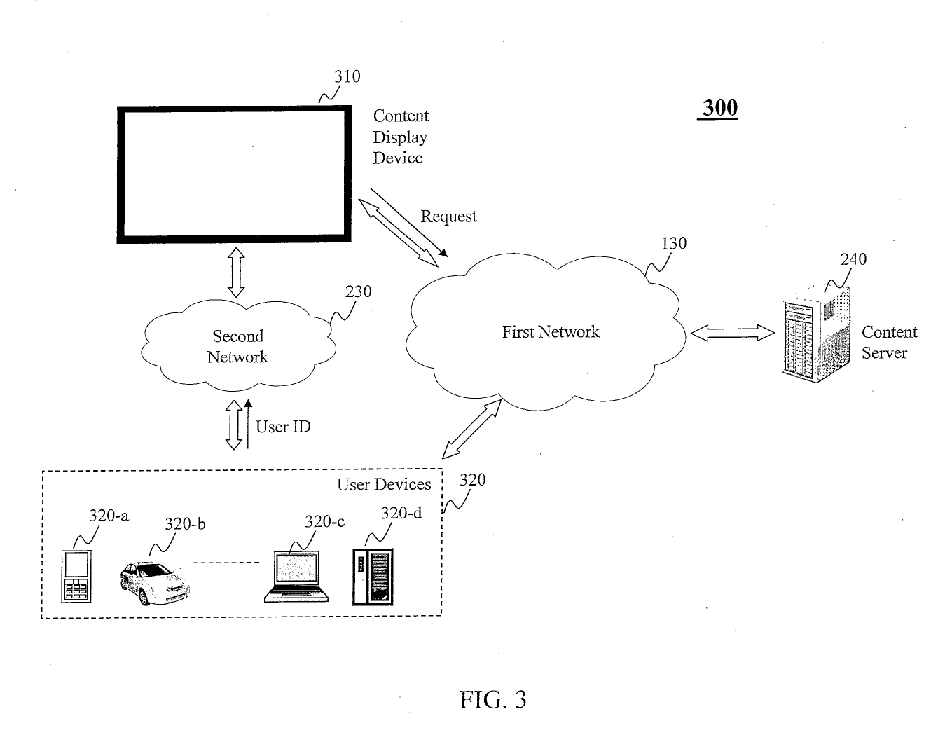

FIG. 3 illustrates another exemplary system 300 for presenting personalized content based on user IDs of users, in accordance with one embodiment of the present teaching. The system 300 in this embodiment has a similar structure to the system 200. The system 300 may include a content display device 310, a first network 130, a second network 230, a content server 240, and a plurality of user devices 320 carried by some users.

Different from the system 200, in the system 300, the user devices 320 actively send user IDs to the content display device 310. When a user carrying a user device is close to the content display device 310, a user ID sent out by the user device may be detected by the content display device 310, via the second network 230. Upon receiving the user ID, the content display device 310 may send a request to the content server 240. The request may include both the device ID and the user ID. The content server 240 can retrieve records associated with the user ID to determine some identified personal interests for the user, and generate personalized content based on the identified personal interests. The personalized content can be sent to and presented at the content display device 310.

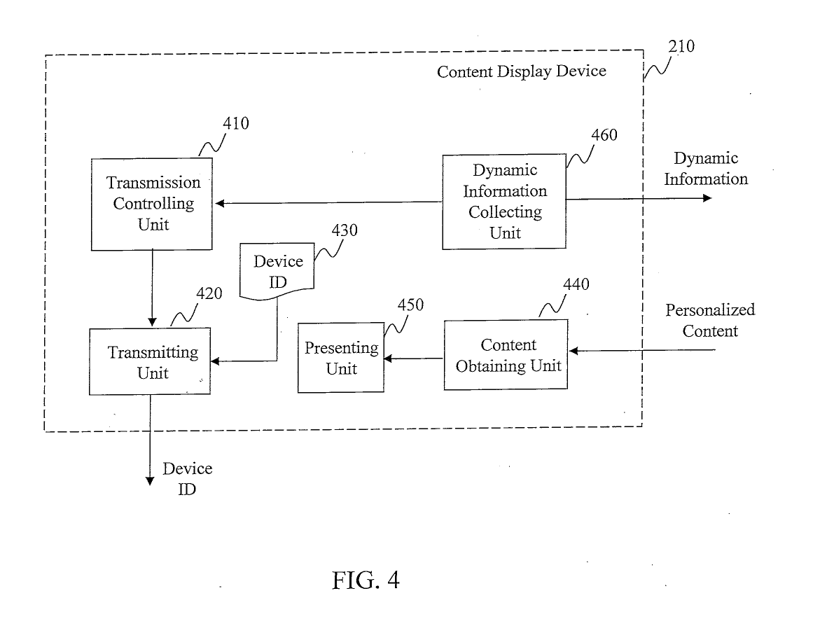

FIG. 4 is a block diagram of an exemplary embodiment of a content display device 210, in accordance with one embodiment of the present teaching. The content display device 210 in this embodiment includes a transmission controlling unit 410, a transmitting unit 420, a content obtaining unit 440, a presenting unit 450, and a dynamic information collecting unit 460. The transmission controlling unit 410 may determine a transmission range for transmitting a device ID 430 of the content display device 210. The transmission range may be determined based on a transmit power and/or a transmitting direction associated with the device ID transmission. The transmitting unit 420 can transmit the device ID 430 according to the determined transmission range, to user devices within the range, via the second network 230.

The content obtaining unit 440 may be configured for receiving personalized content from the content server 240, via the first network 130. The personalized content is generated based on a request from a user. The presenting unit 450 may present the received content to the user.

The dynamic information collection unit 460 is configured for collecting dynamic information related to previous users' actions. In one case, the dynamic information may include users' dwelling time within a predetermined range. In another case, when the content display device 210 has a touchable liquid crystal display (LCD), the dynamic information may include users' reaction on the LCD upon viewing presented content. The dynamic information may be collected continuously. The dynamic information collection unit 460 may send the collected dynamic information to the transmission controlling unit 410 and the content server 240. The transmission controlling unit 410 may determine a transmission range based on the dynamic information. The content server 240 may generate the personalized content based on the dynamic information.

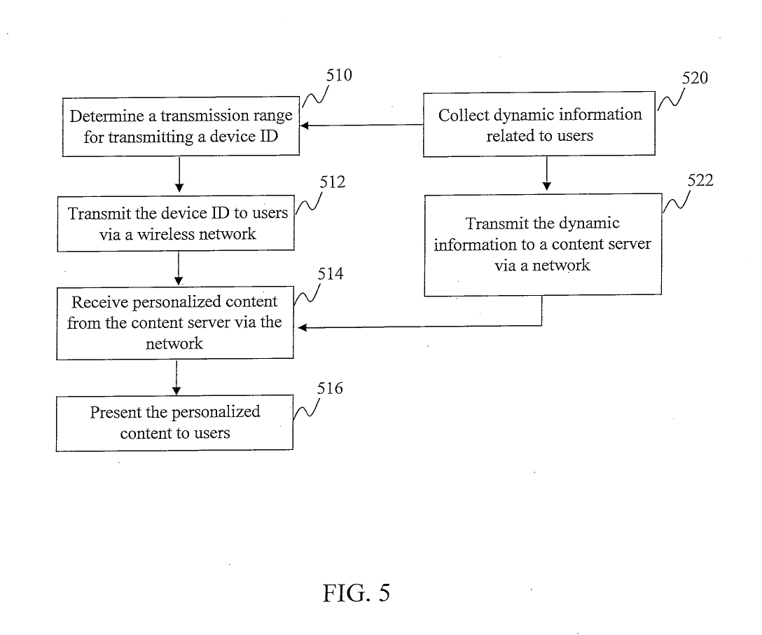

FIG. 5 is a flow chart of an exemplary process performed by the content display device 210, in accordance with one embodiment of the present teaching. At 520, dynamic information related to users can be collected continuously. At 522, the dynamic information may be transmitted to a content server 240 via the first network 130.

At 510, a transmission range may be determined based on the dynamic information. Then a device ID of the content display device 210 can be transmitted, at 512, to users within the transmission range, via the second network 230. At 514, personalized content may be received at the content display device 210 from the content server 240. The personalized content may be generated based on a request from a user. The request may be associated with both the device ID and a user ID of the user. The personalized content may then be presented to the users at 516.

When there are multiple requests from a group of users, the personalized content is generated based on a group interest of the group of users and presented to the group of users at 516. For example, when there are two users sending two requests associated with the content display device 210-a, personal interests can be identified for both users based on the user IDs sent in association with the requests. The content generated and presented at the content display device 210-a, may then be personalized regarding to both users' interests. In case the two users have different interests, different content associated with the different interests may be presented together at the content display device 210-a, but at different places or different time periods. For example, content for one user may be presented at the left side of the screen of the content display device 210-a; and content for the other user may be presented at the right side. In another example, content for one user and the other may be presented each for five seconds, in turn.

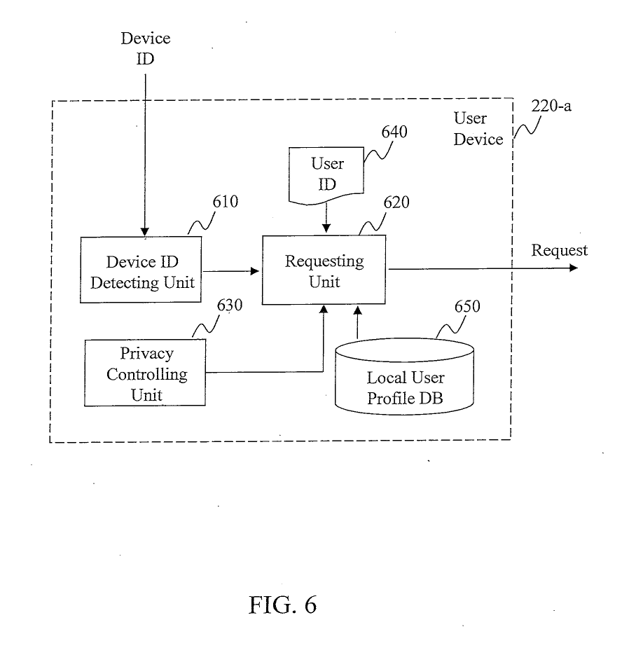

FIG. 6 is a block diagram of an exemplary embodiment of a user device 220-a of a user, in accordance with one embodiment of the present teaching. The user device 220-a may include a device ID detecting unit 610, a requesting unit 620, and a privacy controlling unit 630. The device detecting unit 610 may detect a device ID via the second network 230. The requesting unit 620 may generate and send a request to the content server 240, via the first network 130. The request may be sent in association with the device ID, the user ID 640 stored at the user device 220-a, and/or additional user information that the user allows to send. The privacy controlling unit 630 may determine a privacy level associated with the additional information sent with the request. The privacy level may be predetermined by the user. For example, a high privacy level may represent that the user wants to send as little information as possible. Thus only the user ID and the device ID may be sent with the request. Otherwise, a low privacy level may represent that the user wants to send more information than the user ID and device ID. Then additional user information can be retrieved from a local user profile database 650 at the user device 220-a, and sent with the request to the content server 240. For example, the additional user information may include information stored in the user's cookies of a browser on the device 220-a.

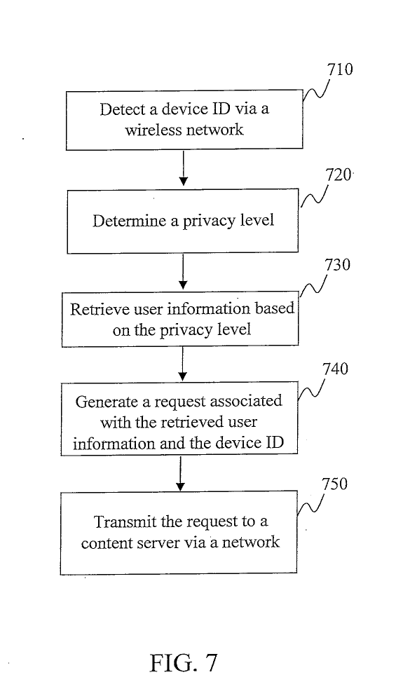

FIG. 7 is a flow chart of an exemplary process performed by the user device 220-a of a user, in accordance with one embodiment of the present teaching. At 710, a device ID may be detected via the second network 230. At 720, a privacy level can be determined based on the user's input or based on the type of the user device 220-a. For example, a cell phone may be set up with a higher privacy level than a car, since a cell phone could be more vulnerable to be stolen than a car. At 730, user information can be retrieved based on the determined privacy level. In some embodiments, no additional user information may be retrieved other that the user ID. In other embodiments, all user information stored in a local database at the device 220-a may be retrieved. The a request may be generated, at 740. The request may be in association with the device ID and the retrieved user information. At 750, the request may be sent to the content server 240 via the first network 130.

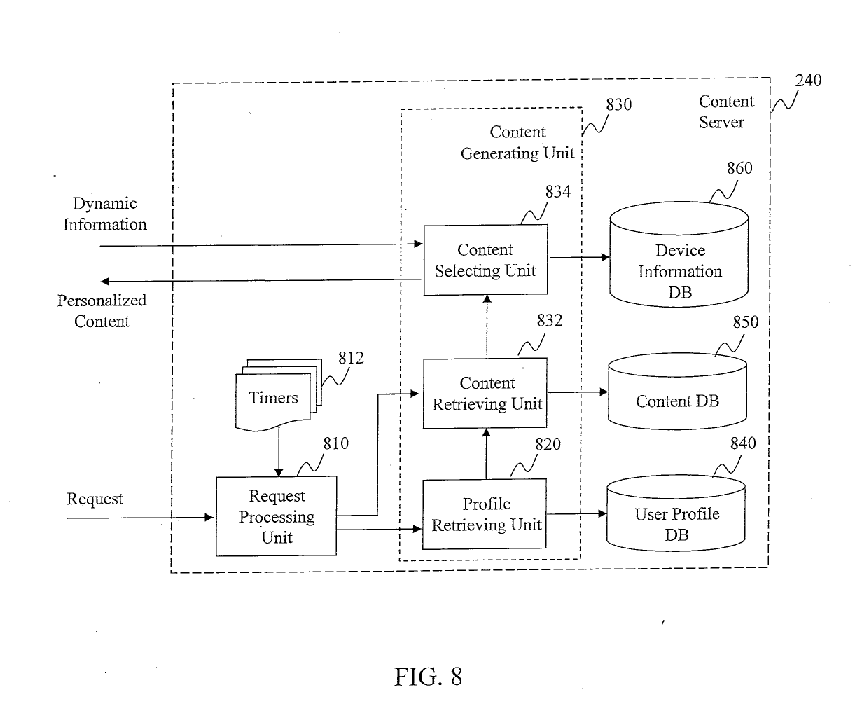

FIG. 8 is a block diagram of an exemplary embodiment of a content server 240, in accordance with one embodiment of the present teaching. The content server 240 in this embodiment includes a request processing unit 810, a content generating unit 830, and some databases 840, 850, 860. The databases may include a user profile database 840, a content database 850, and a device information database 860. The user profile database 840 may include user profiles related with users' activity records that can be used to identify personal interests of the users. The content database 850 may include content of advertisements, news, public information, etc, that can be presented at the content display device 210 or 310. The device information database 860 may include information related to different content display devices, e.g., their sizes, their locations, whether they have a touchable LCD, etc. The device information may be used for selecting personalized content to be presented at a corresponding device. It can be understood that in some embodiments, the databases 840, 850, 860 may be located outside and connected to the content server 240, e.g., via the first network 130.

The request processing unit 810 may receive and process one or more requests. The requests may be associated with different user IDs and different device IDs. The request processing unit 810 may categorize requests based on their associated device IDs. For example, all requests received with a predetermined time period and associated with a same device ID, can be processed together. In accordance with some embodiments, since different device IDs may correspond to different determined time periods or different starting points of a time period, timers 812 located in the content server 240 can be utilized to control the process, with respect different device IDs. Each one of the timers 812 may correspond to a different device ID.

When a group of requests from a group of users related to one device ID is obtained within a predetermined time period, user information can be detected from the group of requests at the request processing unit 810. It can be understood that in some embodiment, the group of request may include only one request from one user. The user information may be sent to the content generating unit 830 for generating personalized content according to the group of requests.

The content generating unit 830 may include a profile retrieving unit 820, a content retrieving unit 832, and a content selecting unit 834. In one embodiment, the profile retrieving unit 820 may retrieve user profiles from the user profile database 840 based on the user information. The content retrieving unit 832 may retrieve content from the content database 850 based on the user profiles. Since the user profiles may include identified personal interests for the group of users, the content retrieved at the content retrieving unit 832 can be treated as personalized content for the group of users.

For example, suppose there are two requests in the group of requests from two users; one user profile identifies personal interests in tennis and beer, another user profile identifies personal interests in travel and beer. Then content related to all of the topics of interests can be retrieved at the content retrieving unit 832, to address the personal interests of the two users.

The content selecting unit 834 may select some content from the retrieved content, based on dynamic information obtained from the device corresponding to the device ID, some device information from the device information database 860, and/or the retrieved content at the content retrieving unit 832. Still referring the above example, the content retrieved based on beer can be selected with a first priority since both users have a specific interest in it. Whether other content can be selected may depend on the size of the corresponding device, or the dwelling time of users at the corresponding device when content related to beer was presented previously. The selected personalized content may be sent to the content display device 210 or 310 for presenting.

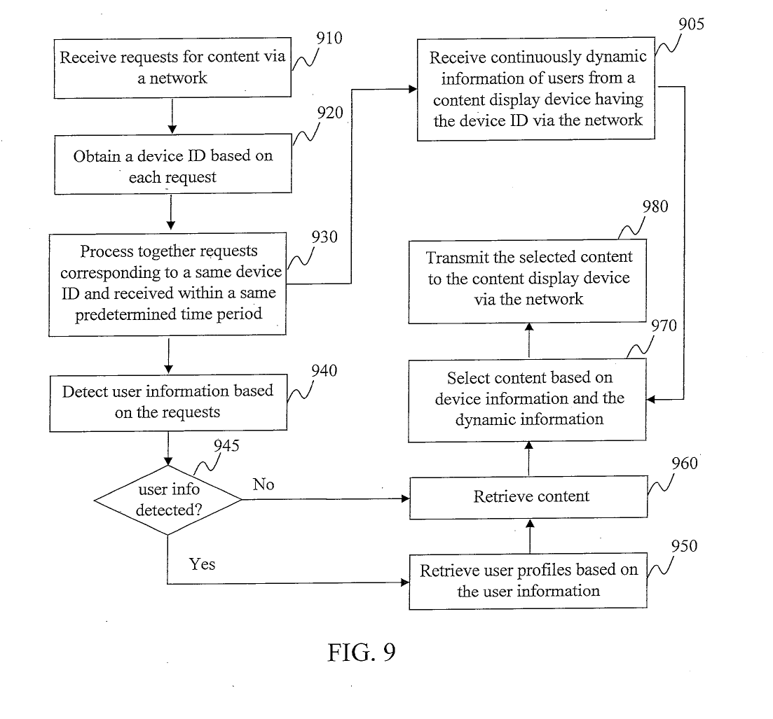

FIG. 9 is a flow chart of an exemplary process performed by the content server 240, in accordance with one embodiment of the present teaching. At 910, requests may be received via the first network 130. At 920, a device ID can be obtained based on each request. The requests corresponding to a same device ID and received within a same predetermined time period may be processed together, at 930. The requests can be combined as a group of requests associated with the device ID.

At 905, dynamic information may be received. The dynamic information can be related to users and a content display device corresponding to the device ID. At 940, user information may be detected based on the group of requests. At 950, it can be determined that whether some user information has been detected. If so, user profiles may be retrieved based on the user information at 950, and content can be retrieved based on the retrieved user profiles at 960. The content may be associated with identified interests of the group of users based on the retrieved user profiles. If no user information has been detected, the process may directly move to 960 to retrieve content based on the device ID only. In this case, the content may be regular advertisements to be presented to public people.

At 970, some or all of the retrieved content can be selected based on: the device information associated with the device ID, the dynamic information collected at the device having the device ID, and/or the retrieved content and identified topics of interests of the group of users. The selected content may then be transmitted to the content display device associated with the device ID at 980, for presenting the content at the content display device.

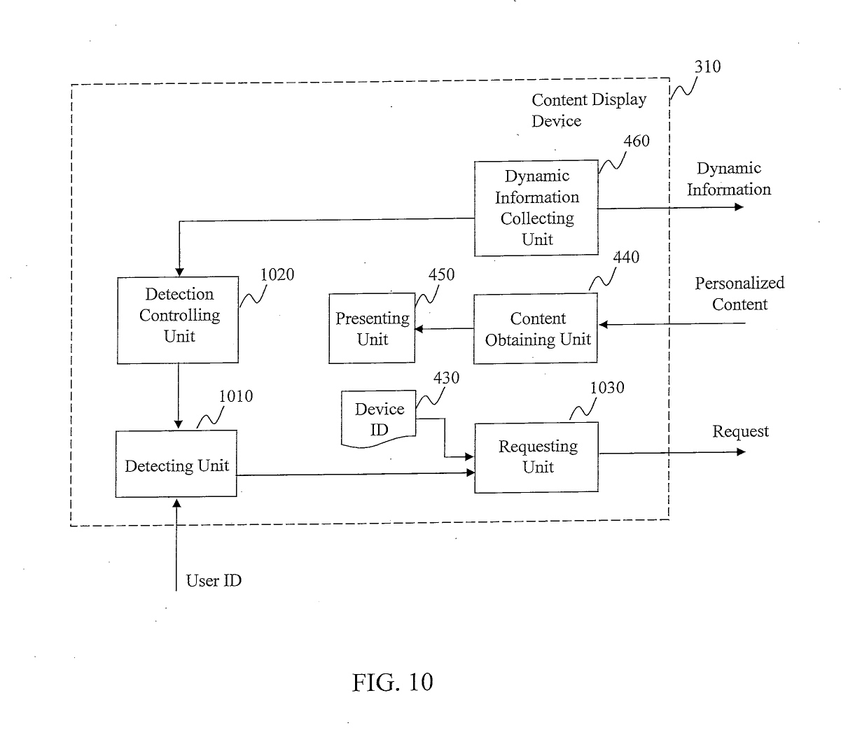

FIG. 10 is a block diagram of another exemplary embodiment of a content display device 310, in accordance with one embodiment of the present teaching. The content display device 310 in this embodiment includes a detection controlling unit 1020, a detecting unit 1010, a content obtaining unit 440, a presenting unit 450, a requesting unit 1030, and a dynamic information collecting unit 460. The detection controlling unit 1020 may determine a detection range for detecting a user ID of a user. The detection range may be determined based on a detection direction associated with the user ID detection. The detection range may be determined based on a detection threshold, so that only user IDs received with signal strength that is higher than the detection threshold can be determined to be detected. The detecting unit 1010 can detect the user IDs according to the determined detection range, from user devices carried by users located within the detection range, via the second network 230.

The requesting unit 1030 may generate a request based on the received user ID and a device ID 430 of the content display device 310. The content obtaining unit 440 may be configured for receiving personalized content from the content server 240, via the first network 130. The personalized content is generated based on the request generated at the requesting unit 1030. The presenting unit 450 may present the received content to the corresponding user.

The dynamic information collection unit 460 is configured for collecting dynamic information related to previous users' actions. In one case, the dynamic information may include users' dwelling time within a predetermined range. In another case, when the content display device 210 has a touchable LCD, the dynamic information may include users' reaction on the LCD upon viewing presented content. The dynamic information may be collected continuously. The dynamic information collection unit 460 may send the collected dynamic information to the detection controlling unit 1020 and the content server 240. The detection controlling unit 1020 may determine a detection range based on the dynamic information. The content server 240 may generate the personalized content based on the dynamic information.

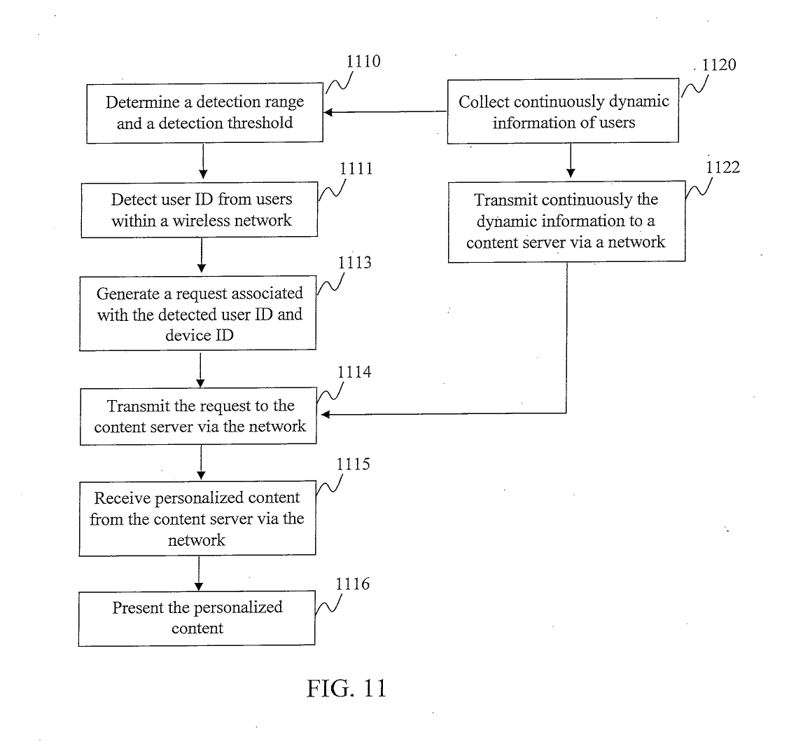

FIG. 11 is a flow chart of another exemplary process performed by the content display device 310, in accordance with one embodiment of the present teaching. At 1120, dynamic information related to users and/or the content display device 130 can be collected continuously. At 1122, the dynamic information may be transmitted to a content server 240 via the first network 130.

At 1110, a detection range may be determined based on the dynamic information and a detection threshold. Then user IDs may be detected at the content display device 310, at 1111, from users within the detection range, via the second network 230. At 1113, a request is generated based on the detected user IDs within a predetermined time period and a device ID of the content display device 310. In some embodiments, there may be only one user ID detected within the predetermined time period. At 1114, the request is transmitted to the content server 240, e.g., via the first network 130. At 1115, personalized content may be received at the content display device 310 from the content server 240. The personalized content may then be presented to the users at 1116.

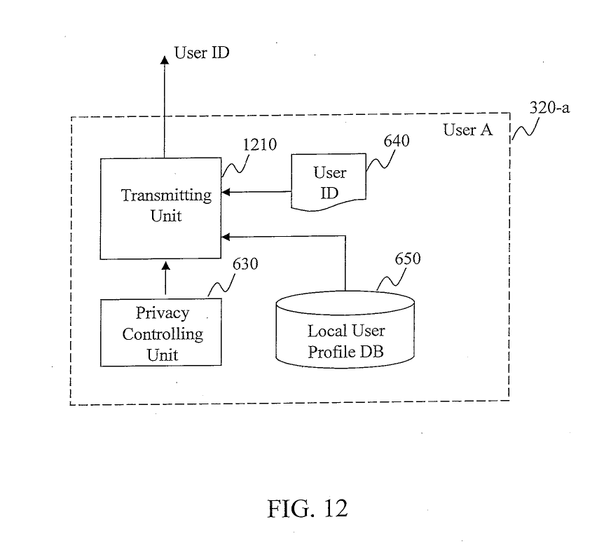

FIG. 12 is a block diagram of another exemplary embodiment of a user device 320-a, in accordance with one embodiment of the present teaching. The user device 320-a may include a transmitting unit 1210 and a privacy controlling unit 630. The transmitting unit 1210 may transmit a user ID 640 stored at the user device 320-a to some content display devices, e.g., via the second network 230. In accordance with some embodiments, the user ID may be sent in association with the some additional user information. The privacy controlling unit 630 may determine a privacy level associated with the additional user information sent with the user ID. The privacy level may be predetermined by the user. For example, a high privacy level may represent that the user wants to send as little information as possible. Thus only the user ID may be sent. In another example, a low privacy level may represent that the user wants to send more information than the user ID. Then additional user information can be retrieved from a local user profile database 650 at the user device 320-a, and sent with the user ID to some content display devices. For example, the additional user information may include information stored in the user's cookies of a browser on the device 320-a.

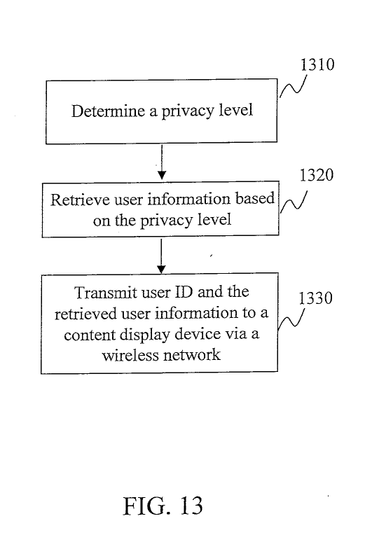

FIG. 13 is a flow chart of another exemplary process performed by the user device 320-a, in accordance with one embodiment of the present teaching. At 1310, a privacy level can be determined, e.g., based on the user's input or based on the type of the user device 320-a. At 1320, user information can be retrieved based on the determined privacy level. In some embodiments, no additional user information may be retrieved other that the user ID. In other embodiments, all user information stored in a local database at the device 320-a may be retrieved. At 1330, the retrieved user information may be transmitted to a content display device, e.g., via the second network 230.

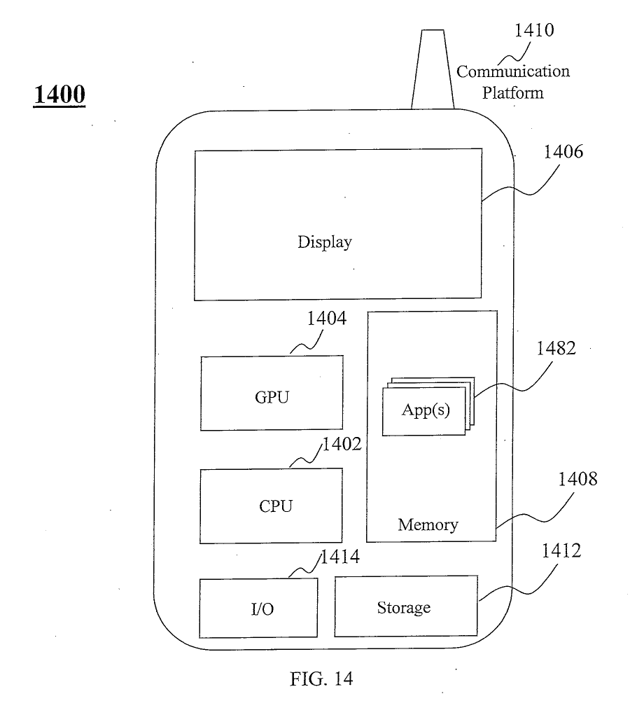

FIG. 14 depicts a general mobile device architecture on which the present teaching can be implemented and has a functional block diagram illustration of a mobile device hardware platform which includes user interface elements. The mobile device may be a general-purpose mobile device or a special purpose mobile device. In this example, the user device is a mobile device 1400, including but is not limited to, a smart phone, tablet, music player, handled gaming console, GPS. The mobile device 1400 in this example includes one or more central processing units (CPUs) 1402, one or more graphic processing units (GPUs) 1404, a display 1406, a memory 1408, a communication platform 1410, such as a wireless communication module, storage 1412, and one or more input/output (I/O) devices 1414. Any other suitable component, such as but not limited to a system bus or a controller (not shown), may also be included in the mobile device 1400. As shown in FIG. 14, one or more applications 1482 may be loaded into the memory 1408 from the storage 1412 in order to be executed by the CPU 1402. The applications 1482 may be executed on various mobile operating systems, e.g., iOS, Android, Windows Phone, etc. Execution of the applications 1482 may cause the mobile device 1400 to perform the processing as described above, e.g., in FIGS. 5, 7, 11, and 13.

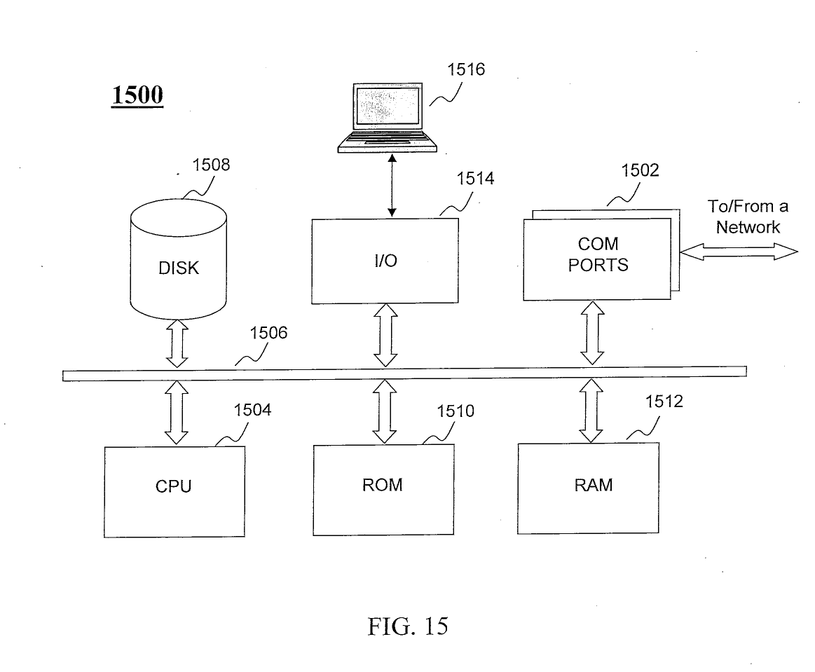

FIG. 15 depicts a general computer architecture on which the present teaching can be implemented and has a functional block diagram illustration of a computer hardware platform which includes user interface elements. The computer may be a general-purpose computer or a special purpose computer. This computer 1500 can be used to implement any components of the system for presenting personalized content as described herein. Different components of the system 200, 300, e.g., as depicted in FIGS. 2 and 3, can all be implemented on one or more computers such as computer 1500, via its hardware, software program, firmware, or a combination thereof. Although only one such computer is shown, for convenience, the computer functions relating to dynamic relation and event detection may be implemented in a distributed fashion on a number of similar platforms, to distribute the processing load.

The computer 1500, for example, includes COM ports 1502 connected to and from a network connected thereto to facilitate data communications. The computer 1500 also includes a central processing unit (CPU) 1504, in the form of one or more processors, for executing program instructions. The exemplary computer platform includes an internal communication bus 1506, program storage and data storage of different forms, e.g., disk 1508, read only memory (ROM) 1510, or random access memory (RAM) 1512, for various data files to be processed and/or communicated by the computer, as well as possibly program instructions to be executed by the CPU. The computer 1500 also includes an I/O component 1514, supporting input/output flows between the computer and other components therein such as user interface elements 1516. The computer 1500 may also receive programming and data via network communications.

Hence, aspects of the method for presenting personalized content, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the computer-implemented method.

All or portions of the computer-implemented method may at times be communicated through a network such as the Internet or various other telecommunication networks. Such communications, for example, may enable loading of the software from one computer or processor into another. Thus, another type of media that may bear the elements of the computer-implemented method includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the computer-implemented method. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teaching is amenable to a variety of modifications and/or enhancements. For example, although the implementation of various components described above may be embodied in a hardware device, it can also be implemented as a firmware, firmware/software combination, firmware/hardware combination, or a hardware/firmware/software combination.

While the foregoing description and drawings represent embodiments of the present teaching, it will be understood that various additions, modifications, and substitutions may be made therein without departing from the spirit and scope of the principles of the present teaching as defined in the accompanying claims. One skilled in the art will appreciate that the present teaching may be used with many modifications of form, structure, arrangement, proportions, materials, elements, and components and otherwise, used in the practice of the disclosure, which are particularly adapted to specific environments and operative requirements without departing from the principles of the present teaching. The presently disclosed embodiments are therefore to be considered in all respects as illustrative and not restrictive, the scope of the present teaching being indicated by the appended claims and their legal equivalents, and not limited to the foregoing description.

What is claimed is:

1. A method, implemented on a machine having at least one processor, storage, and a communication platform connected to a network for presenting content, comprising:
determining a range with respect to a presenting device;
transmitting, via the communication platform, a device identification (ID) of the presenting device to a first user located within the range;
obtaining first content generated based on a first request from the first user, wherein the first request is sent in association with at least the device ID and a first user ID of the first user; and
presenting, at the presenting device, the first content, wherein the first content is personalized with respect to the first user.

2. The method of claim 1, wherein the step of determining a range with respect to a presenting device comprises:
collecting dynamic information related to one or more users located within at least one range with respect to the presenting device; and
selecting a range from the at least one range based on the dynamic information.

3. The method of claim 1, further comprising:
transmitting the device ID to a second user located within the range, wherein the second user has a second user ID;
obtaining second content generated based on a second request from the second user, wherein the second request is sent by the second user in association with at least the device ID and the second user ID; and
presenting, at the presenting device, the second content, wherein the second content is personalized with respect to the second user, and the first content and the second content are presented separately.

4. The method of claim 3, wherein the first content and the second content are generated at a serving device.

5. The method of claim 1, wherein:
the first request is sent with additional user information; and
the additional user information is determined based on at least a predetermined privacy level.

6. A method, implemented on a machine having at least one processor, storage, and a communication platform connected to a network for presenting content, comprising:
determining a range with respect to a presenting device having a device ID;
detecting a first user ID associated with a first user located within the range;
generating a first request in association with at least the device ID and the first user ID;
obtaining first content personalized based on the first request; and
presenting, at the presenting device, the first content.

7. The method of claim 6, wherein the step of determining a range with respect to a presenting device comprises:
collecting dynamic information related to one or more users located within at least one range with respect to the presenting device; and
selecting a range from the at least one range based on the dynamic information.

8. The method of claim 6, further comprising:
detecting a second user ID associated with a second user located within the range;
generating a second request in association with at least the device ID and the second user ID;
obtaining second content personalized based on the second request; and
presenting, at the presenting device, the second content, wherein the first content and the second content are presented separately.

9. The method of claim 8, wherein the first content and the second content are generated at a serving device.

10. The method of claim 6, further comprising detecting additional user information associated with the first user, wherein the additional user information is determined based on at least a predetermined privacy level.

11. A method, implemented on a machine having at least one processor, storage, and a communication platform connected to a network for presenting content, comprising:
receiving a first request, wherein
the first request is sent in association with at least a device ID of a presenting device and a first user ID of a first user, and
the first user is located within a predetermined range with respect to the presenting device;
generating first content personalized based on the first request; and
transmitting the first content to the presenting device, wherein the presenting device presents the first content.

12. The method of claim 11, wherein the step of generating first content comprises:
receiving dynamic information related to the presenting device and one or more users located within the predetermined range;
obtaining a user profile based on the first user ID;
obtaining content personalized based on the user profile; and
selecting first content from the obtained content based on the dynamic information.

13. The method of claim 11, further comprising:
receiving a second request, wherein the second request is sent in association with at least the device ID and a second user ID of a second user located within the predetermined range;
generating second content personalized based on the second request; and
transmitting the second content to the presenting device, wherein the presenting device presents the first content and the second content separately.

14. An apparatus including at least one processor, storage, and a communication platform connected to a network for presenting content, comprising:
a transmission controlling unit configured for determining a range with respect to the apparatus;
a transmitting unit configured for transmitting, via the communication platform, a device ID of the apparatus to a user located within the range;
a content obtaining unit configured for obtaining content generated based on a request from the user, wherein the request is sent in association with at least the device ID and a user ID of the user; and
a presenting unit configured for presenting the content, wherein the content is personalized with respect to the user.

15. The apparatus of claim 14, further comprising a dynamic information collecting unit configured for collecting dynamic information related to one or more users located within at least one range with respect to the apparatus, wherein the transmission controlling unit is further configured for selecting a range from the at least one range based on the dynamic information.

16. An apparatus including at least one processor, storage, and a communication platform connected to a network for presenting content, comprising:
a detection controlling unit configured for determining a range with respect to the apparatus, wherein the apparatus has a device ID;
a detecting unit configured for detecting a user ID associated with a user located within the range;
a requesting unit configured for generating a request in association with at least the device ID and the user ID;
a content obtaining unit configured for obtaining content personalized based on the request; and
a presenting unit configured for presenting the content.

17. The apparatus of claim 16, further comprising a dynamic information collecting unit configured for collecting dynamic information related to one or more users located within at least one range with respect to the apparatus, wherein the detection controlling unit is further configured for selecting a range from the at least one range based on the dynamic information.

18. An apparatus including at least one processor, storage, and a communication platform connected to a network for presenting content, comprising:
a request processing unit configured for receiving a request for content, wherein
the request is sent in association with at least a device ID of a presenting device and a user ID of a user, and
the user is located within a predetermined range with respect to the presenting device; and
a content generating unit configured for
generating content personalized based on the request, and
transmitting the content to the presenting device, wherein the presenting device presents the content.

19. The apparatus of claim 18, wherein the content generating unit further comprises:
a profile retrieving unit configured for obtaining a user profile based on the user ID;
a content retrieving unit configured for obtaining content personalized based on the user profile; and
a content selecting unit configured for
receiving dynamic information related to the presenting device and one or more users located within the predetermined range, and
selecting content from the obtained content based on the dynamic information.

20. A system including at least one processor, storage, and a communication platform connected to a network for presenting content, comprising:
a presenting device;
a serving device; and
a content presentation mechanism residing in both the presenting device and the serving device, wherein
the presenting device
determines a range with respect to the presenting device, and
transmits a device ID of the presenting device to a user located within the range,
the serving device
receives a request from the user, wherein the request is sent in association with at least the device ID and a user ID of the user ID,
generates content personalized with respect to the user based on the request, and
transmits the content to the presenting device, and the presenting device
receives the content from the serving device, and
presents the content.

21. A system including at least one processor, storage, and a communication platform connected to a network for presenting content, comprising:
a presenting device having a device ID;
a serving device; and
a content presentation mechanism residing in both the presenting device and the serving device, wherein
the presenting device
determines a range with respect to the presenting device,
detects a user ID associated with a user located within the range,
generates a request in association with at least the device ID and the user ID, and
transmits the request to the serving device,
the serving device
receives the request,
generates content personalized with respect to the user based on the request, and
transmits the content to the presenting device, and the presenting device
receives the content from the serving device, and
presents the content.

22. A machine-readable tangible and non-transitory medium having information for presenting content, wherein the information, when read by the machine, causes the machine to perform the following:
determining a range with respect to a presenting device;
transmitting, via the communication platform, a device identification (ID) of the presenting device to a first user located within the range;
obtaining first content generated based on a first request from the first user, wherein the first request is sent in association with at least the device ID and a first user ID of the first user; and
presenting, at the presenting device, the first content, wherein the first content is personalized with respect to the first user.

23. A machine-readable tangible and non-transitory medium having information for presenting content, wherein the information, when read by the machine, causes the machine to perform the following:
determining a range with respect to a presenting device having a device ID;
detecting a first user ID associated with a first user located within the range;
generating a first request in association with at least the device ID and the first user ID;
obtaining first content personalized based on the first request; and
presenting, at the presenting device, the first content.

24. A machine-readable tangible and non-transitory medium having information for presenting content, wherein the information, when read by the machine, causes the machine to perform the following:
receiving a first request, wherein
the first request is sent in association with at least a device ID of a presenting device and a first user ID of a first user, and
the first user is located within a predetermined range with respect to the presenting device;
generating first content personalized based on the first request; and
transmitting the first content to the presenting device, wherein the presenting device presents the first content.
